(19) United States
(12) Patent Application Publication
(10) Pub. No.: US 2011/0155903 A1
(43) Pub. Date: Jun. 30, 2011

(54) SIMULTANEOUS INORGANIC MASS SPECTROMETER AND METHOD OF INORGANIC MASS SPECTROMETRY

(75) Inventors: Dirk Ardelt, Krefeld (DE); Ulrich Heynen, Kalkar (DE); Adi A. Scheidemann, Baden (CH)

(73) Assignee: Spectro Analytical Instruments GmbH, Kleve (DE)

(21) Appl. No.: 12/981,607

(22) Filed: Dec. 30, 2010

Related U.S. Application Data
(60) Provisional application No. 61/291,562, filed on Dec. 31, 2009.

(51) Int. Cl. B01D 59/44; H01J 49/12

(52) U.S. Cl. 250/282; 250/288

(57) ABSTRACT

An inorganic mass spectrometer capable of measuring a relevant and large or the full mass spectral range simultaneously may include a suitable ion source (e.g., an ICP mass spectrometer with an ICP ion source), an ion transfer region, an ion optics to separate ions out of a plasma beam, a Mattauch Herzog type mass spectrometer with a set of charged particle beam optics to condition the ion beam before the entrance slit, and a solid state multi channel detector substantially separated from ground potential and separated from the potential of the magnet is introduced.

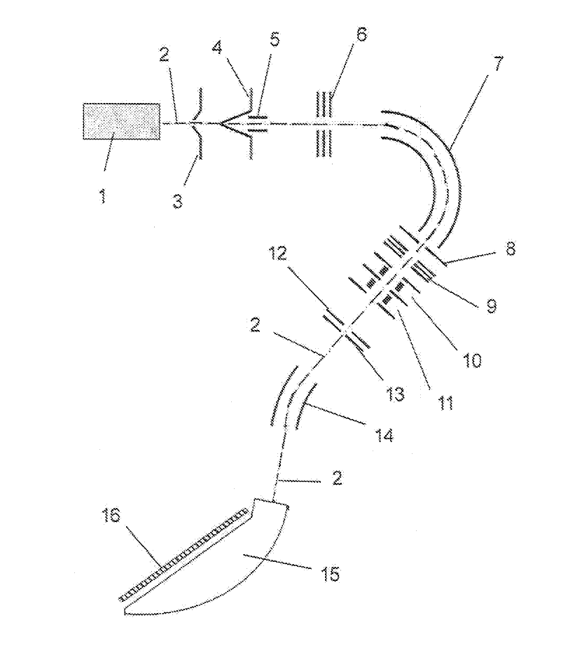

### CROSS-REFERENCE TO RELATED APPLICATIONS

This application claims priority to U.S. Provisional Patent Application No. 61/291,562, filed on Dec. 31, 2009, and incorporated herein by reference.

### FIELD OF THE INVENTION

Embodiments of the present invention relates to the area of inorganic mass spectrometry. Known, but in no way limiting, implementations of inorganic mass spectrometry (MS) in the context of the invention claimed are ICP-MS, GD-MS, TIMS or Spark Source MS.

### BACKGROUND

In the field of inorganic mass spectrometry, a constant necessity exists for yet even higher sensitivity, faster speed of measurement and greater precision, the latter e.g. for isotope ratio measurements or the use of isotope dilution analysis. ICP-MS, using an inductively coupled Argon plasma (“ICP”) at atmospheric pressure as the ionization source, has become the de-facto standard for inorganic mass spectrometry aiming at (trace and ultra-trace) concentration measurements. GD-MS, using a (typically Ar) glow discharge (DC or RF) at reduced pressure allows for sensitive direct concentration analysis of solid materials and thin layers, without digestion steps that might be required for (liquid sample based) ICP-MS, whereas TIMS, thermal ionization mass spectrometry, is mainly used for precise isotope ratio determinations, mainly in the geological field.

For ICP-MS, the mainstay (90% of the ICP-MS units shipped in 2005, Source: Global Assessment Report 9^{th} Edition “The Laboratory Analytical and Life Science Instrument Industry 2006-2010”, SDI Los Angeles, September 2006) of commercially available instruments still employ a quadrupole mass filter as analyzer, a truly sequential ('mass filtering') device. Additionally, “high mass resolution” variants, employing a scanning sector field mass analyzer, e.g. of the (reverse) Nier-Johnson design, are known, which, using a single detector, again are sequential in nature. Only a very small amount of “semi-simultaneous” inorganic mass spectrometers exist commercially, either employing several (normally <10) detectors that can be moved in a focal plane, or using a time-of-flight mass analyzer. Up to now, no fully simultaneous (=allowing to simultaneously capture the full inorganic mass spectrum in one or only few (≦3) measurements) are commercially available, very much contrary to the situation in atomic emission spectrometry, where sequential spectrometers have mainly been replaced by simultaneous full-spectrum instruments.

Besides concentration information, also ICP-MS and GD-MS allow for the determination of isotope ratios of sample constituents. However, for precise isotope ratio determination, present day instrumentation in the field of inorganic mass spectrometry for a large part is limited by its sequential nature, resulting from the technologies employed. Caused by the unavoidable ion source fluctuations in both time and space, known e.g. as flicker noise for ICP-MS, the achievable precision for isotope ratio determinations is fundamentally limited for a sequential device, such as a quadrupole mass filter or a scanning sector field mass analyzer.

Apart from a more precise determination of isotope ratios, also other reasons make a (fully) simultaneous inorganic mass spectrometer desirable. For instance, the “multiplex” or “Fellgett's Advantage” dictates that for a continuous multi-channel signal and for a given total integration time a simultaneous measurement of all channels results in a better signal-to-noise ratio than a sequential channel after channel measurement of the same (total) integration time. In inorganic mass spectrometry, this advantage translates into shorter measurement times to reach the same signal to background ratio, especially if many masses (isotopes) are to be measured (as in typical environmental applications). Shorter measurement times per sample increase the sample throughput, with the positive effects of less sample consumption (and the possibility of using smaller sample volumes), less energy and media consumption and finally less waste production.

Apart from higher sample throughput, in inorganic mass spectrometry, faster measurement times, independent of the number of channels (=isotopes) sampled, are of great interest for all methods generating transient signals, signals that change as a function of time. Among such methods are, for instance, the on-line coupling to inorganic mass spectrometry instruments (“hyphenation”) of separation systems like gas- or liquid phase chromatography, of direct solid sample introduction systems like electro-thermal vaporization, spark or laser ablation, or of flow injection systems. All transient signal generating methods require short measurement times per data point in time, to avoid the so-called “peak skewing”, caused by missing the maximum signal of a given transient signal resulting from slow scanning, as found in sequential devices (transient signal artifacts resulting from insufficient sampling frequency). Thus, for sequential devices, the amount of channels that can be measured reliably with (fast) transient signals is strongly limited, compared to a (fully) simultaneous device, able to measure “all” channels reliably as a function of time. With hyphenation methods gaining more and more interest in inorganic mass spectrometry, it is obvious that a (fully) simultaneous device is instrumental in achieving better data quality with transient measurements.

The same benefit of shorter measurement times applies for GD-MS e.g. in the case of thin layers analysis. Here, the amount of constituents that can be determined simultaneously with a given depth resolution is limited by the scan speed of a sequential device. In contrast to that, a (fully) simultaneous instrument allows for a constant depth resolution, independent of the number of constituents desired to be analyzed.

It is thus clear after the aforementioned advantages of such system that a clear need exists for an inorganic mass spectrometer, capable of measuring simultaneously the full inorganic mass range (typically Li⁶ to U²³⁸), in one, or very few (≦3) individual measurements. It is also obvious that this need currently commercially is neither fulfilled by sequential instruments based on the quadrupole mass filter, nor the existing so-called “multi-collector” instruments, having only a very limited number (<10) of simultaneous channels. Apart from the mentioned, also TOF (time-of-flight) mass analyzer based instruments for inorganic mass spectrometry exist commercially. Although TOF based instruments allow for a simultaneous spectrum capture, their pulsed sampling nature resulting from the need of waiting for the ion pulse sampled to fully travel through the drift tube of the analyzer results in a limited sample rate that does not utilize the cw ion beam originating from the ion source, e.g. the atmospheric Ar plasma. Compared to a truly fully simultaneous inorganic mass spectrometer, the TOF analyzer based system exhibit worse signal-to-noise ratios for a given total integration time, depending on their sampling rate and duty cycle, as expected from sampling theory. Again, the advantages of a fully simultaneous system over TOF-based systems are obvious.

One goal of the claimed invention may thus be to remedy this unsatisfying situation by creating a fully simultaneous inorganic mass spectrometer, allowing to measure the full inorganic mass range (typically Li⁶ to U²³⁸) in a single or very few (≦3) measurements. Apart from providing means for a simultaneous measurement over a large mass range, also sufficient signal dynamic range and resolution of adjacent mass signals may be provided, as common in inorganic mass spectrometry; see, e.g., ICP-MS MONTASER for a discussion of typical specifications for commercially available ICP-MS.

### SUMMARY OF EMBODIMENTS OF THE INVENTION

An object of some embodiments of the invention is to provide an inorganic mass spectrometer in which a very wide mass range can be measured truly simultaneously, which allows for an efficient separation of analyte ions and other signal constituents (e.g. photons, electrons, (hot) neutrals)) produced in the ion source and which can partially suppress the carrier gas ions. Suppressing the carrier gas ions allows more accurate measurements in mass ranges close to the mass of the carrier gas ion. The carrier gas may be Argon, but is not limited to.

### BRIEF DESCRIPTION OF THE DRAWINGS

Embodiments of the invention will now be described in conjunction with the attached drawing that shows a diagram of an exemplary structure of an embodiment of the invention.

### DETAILED DESCRIPTION OF EMBODIMENTS OF THE INVENTION

The following describes the claimed invention in the specific implementation as ICP mass spectrometer. However, the invention is not limited to this specific implementation and can be applied in the field of inorganic mass spectrometry in many other obvious ways. For an ICP-MS, the objective may be achieved through a mass spectrometer set up that includes:
An ICP ion source on or close to ground potential
An ion transfer region (“vacuum interface”) with concentric nozzles (sampler and skimmer) and symmetric pump ports
A set of charged particle optics [thereafter called “CPO”] to extract the ions out of the skimmer region
CPO to separate the ions from the plasma beam's other constituents (photons, neutrals, etc.) and to partially separate the carrier gas ions from the analyte ions,
A set of CPO beam optics to precondition the ion beam before the mass spectrometer entrance slit
A Mattauch Herzog type mass spectrometer
A solid state multi channel detector with an electrical potential substantially separated from ground potential and which can also be separated from the magnet potential,
A mask between detector and magnet,
A potential applied to the mask which may be different to both the potentials applied to detector and/or the potential applied to the magnet.

Referring to the attached drawing, the ICP source 1 may be mounted adjacent to the evacuated ion transfer region, thus the plasma beam 2 may hit the sampler nozzle 3. After traversing the sampler nozzle 3, the central part of the beam may be skimmed out by the skimmer nozzle 4. The region between sampler and skimmer may be evacuated to ca. 2 Torr. Two pumping ports (not shown), symmetrically placed, may be used to provide sufficient pumping speed and ensure a symmetric gas flow which does not distort the ion beam.

After passing the skimmer nozzle 4, the charged particles may be extracted out of the vicinity of the skimmer region by the extractor ion lens 5; thus a separation between positively charged ions and electrons may be achieved.

The extractor ion lens 5 may be partially placed into the skimmer 4 to ensure efficient ion transfer. In ICP-MS, the skimmer and especially the extractor ion optics may need periodic cleaning services. To aid the service of the instrument, the skimmer 4 and extractor 5 may be located in a joint mount. By so doing, both of these elements may be conveniently removed as a unit for service.

The positively charged ions [thereafter called “ions”] may be guided by a set of charged particle optics into a first electrostatic sector field [thereafter called “Pre-Filter”]. This Pre-Filter may include a pre-filter lens 6 and electrostatic pre-filter 7, and may act to bend the ion flight pass, and therefore, electrically neutral particles (including any spectral background increasing electronically exited neutral particles) and photons produced by the ion source concomitant with the analyte ions may be separated out of the ion beam, since such neutral particles are not affected by the applied potentials.

Since the Pre-Filter represents an electro static sector analyzer, its ejection angle is a function of the ion energy. The ion energy is provided by:

E-ion=E-potential+E-in-source. (Eq. 1)

The ion energy [E-ion] is dominated by the potential of the ion optics [E-potential], however, the in-source ion energy [E-in-source] cannot be neglected. This component is different for the seeded analyte ions and the carrier gas ions. Since the ejection angle for the ions out of the energy filter is energy dependent, the analyte and carrier gas ions hit the object slit downstream of the Pre-filter at different positions.

This effect, together with the narrow object slit [thereafter called OS], partially separates the carrier gas ions from the analyte ions. While this effect could provide a complete separation, due to the given beam width and the instrument dimensions, the separation described here might not be 100%. If desired, the beam can also be focused almost entirely onto the OS to suppress this separation.

The instrument design may have a differential pumping stage between a vacuum chamber housing the Pre-Filter and a following vacuum chamber. This following vacuum chamber will be called the Main-Chamber.

The differential pumping stage between Pre-Filter and Main-Chamber is designed as charged particle optics. The main chamber may house an Optical-Bench (not shown). This optical-bench may be electrically separated from ground, and according to equation 1, its potential in first approximation defines the ion energy in this stage.

The first group of CPO on the Optical-Bench, following aperture 8, may be a set of Einzel lenses 9 followed by two electrostatic quadrupole elements 10, 11 separated with shunts. These elements may help to focus the beam 2 and image the round beam onto a rectangular object slit 13, located beyond an aperture 12.

In traditional magnetic sector instruments the Object-Slit 13 may be a flat conductive plate holding a narrow slit. This slit may then be imaged onto the detector. Therefore a smaller Object-Slit 13 may provide an increased resolution (see equation 2).

Peakwidth=2^{0.5}×OS Slitwidth×(Radius of Trajectory in Magnet)/(Radius of Trajectory in ESA) Equation 2

The ion trajectories may be shielded with a Faraday shield (not shown) from the electric potential of the vacuum housing which is on ground potential.

After passing the OS 13, the ions may then be separated by energy in the electrostatic sector analyzer 14 [thereafter called “ESA”].

After traversing the ESA 14, the ions may cross an additional aperture (not shown) placed between the magnet 15 entrance and an exit shunt of the electrostatic sector analyzer 14.

This aperture may be placed approximately half way between the two aforementioned optical elements (ESA 14 and Magnet 15). The aperture may be on the potential of the Optical-Bench and may have dimensions (width×height) that may, for example, be determined empirically.

In the Magnet 15, the ions may be separated by momentum—due to the upstream ESA 14, in good approximation, the ions have the same energy—the separation may thus be according to mass. The Magnet 15 may be a classical Mattauch-Herzog layout; a typical gap width may be 6 mm, with a field strength ranging from 0.5 Tesla up to 1.5 Tesla. Typical focal length may be between 50 and 150 mm, and an exemplary implementation of the system presented here may use a focal length of ca. 120 mm.

The Magnet 15 may be mounted onto the Optical-Bench (which is electrically separated from ground); additionally the Magnet 15 may be held in place by a clamp (not shown). This clamp may additionally carry a detector mount. The detector 16 may generally be electrically isolated from (1) the Optical-Bench, (2) the Magnet, and (3) from ground potential.

A mask (not shown) may be placed between the Magnet 15 and the Detector 16. This mask may be electrically isolated from the Magnet 15 and the Detector 16. A potential may be applied to the mask [called “mask potential”].

Since the trajectories of the ions passing through the Magnet 15 are typically not perfectly parallel to the Magnet 15 poles, small angle scattering of the ions against the top and bottom of the Magnet 15 poles may occur. This scattering may lead to a spread of the measured beam width on the detector 16. A mask allowing only the central part of the detector to be exposed to the beam may thus reduce this effect.

A potential applied to the mask may be electrically attractive to electrons that may be released by ions hitting the detector 16 surface (sputtering). These electrons can be captured by the mask, if a suitable potential is applied. With a typical gap in the Magnet 15 of 6 mm, the mask may reach into the gap between 0.5 mm and 1 mm.

The Detector 16 may be composed of:
Monolithic CMOS-Detector with different gains and different collector areas.
Detector-Carrier
Connector-PCB
Peltier cooler
Detector-Body
Water-Cooler
Amplifier-PCB
Fully floatable camera board with optical data communication and isolation against float potential
Fiber optical cable

The charged particle detector may be a monolithic CMOS detector; thus, the charge receiving elements, the bus and/or multiplexer, and (an) amplifier(s) may be placed on a single substrate, such as a single piece of silicon.

To increase the dynamic range of the detector, the unit may have two different gains, and additionally, their charge receiving areas may be different in size. The two different gains may be alternating on the strip charge detector array, whereby the buses/multiplexer are opposing each other.

The signal flow may thus be as follows:

1) The charge is received on the monolithic CMOS-Detector, where this chip may be wire bonded to the Connector-PCB.
2) The Connector-PCB may be connected to the Amplifier-Board, which may also be electrically floated from ground, typically at the detector potential.
3) The Amplifier-Board may be connected the Camera-Board. The Camera-Board may be separated from ground, e.g., by an isolation transformer or a suitable DC:DC converter and may be floated, typically at the detector potential, with a conventional high voltage power supply.
4) The Camera-Board may communicate via an optical data connection via a fiber optic cable connected to the data receiving station

The monolithic CMOS detector may be glued onto a Detector-Carrier, which may preferably be made from metal, e.g. copper.

The glue may preferably be a thermally well-conducting glue such as, but not limited to, thermally conductive epoxy; the thickness of the glue may preferably be as thin as possible, and typical thicknesses may range from 10 to 150 muem.

The Detector-Carrier may hold, besides the CMOS-Detector, two printed circuit boards [Connector-PCB] that may be used to interface the monolithic CMOS detector to an Amplifier-Board. The electrical connection between the CMOS-Detector and the Connector-PCB may be done, e.g., with wire bonding.

The Detector-Carrier may be cooled with two Peltier elements, and this cooling may typically be to substantially below 0 degree Celsius.

The temperature measurement may be performed contactlessly, e.g., via an IR sensor (e.g., of the pyrometric type) to avoid an electrical contact between the Detector-Carrier at high voltage and the temperature read-out electronics.

The Detector-Carrier (and thus the CMOS-Detector and the Connector-PCB) may be electrically isolated form the hot side of the Peltier elements through the ceramic body of the Peltier elements. Therefore, the Peltier elements may act as both cooling medium and electrical isolation body.

The hot side of the Peltier elements may be placed against the Detector-Body. The Detector-Body may be on ground potential, and the Detector-Body may be water cooled.

The Peltier elements may be sandwiched between the Detector-Body and the Detector-Carrier, e.g., using electrically and thermally isolated screws.

Using electrically isolated precision elements, the Detector-Body may be mounted against the Optical-Bench and the clamp holding the Magnet.

The Amplifier-PCB may typically be electrically isolated from the Detector-Body. The amplified electrical signal may be conditioned in the electrically isolated Camera-PCB, A:D converted and handed over to the data acquisition system (e.g., a PC), e.g., via an optical communications link using a fiber optical cable. Thus, a galvanic separation of the floating detector and the data acquisition system can be achieved. The data acquisition system may be used to present spectrometry results to a user and may include a user interface, such as a display, printer, or the like; alternatively, the user interface may be coupled to a further computing device coupled to the data acquisition system.

The electrically floating parts of the detector unit (monolithic CMOS-Detector, Detector-Carrier, Connector-PCB, Amplifier-PCB, Camera-PCB) may be maintained at the same electrical potential; however, this potential may be different from the potential of the Optical-Bench or the Mask or the Magnet.

During assembly a guide on each side may be used to locate the Detector-Carrier against the Detector-Body. Thus, the position of the Detector-Carrier may be well defined once the unit is placed into the instrument.

The described implementation is limited to various embodiments of the invention and in no way limits the scope of the invention. Indeed, many variations of the above embodiments would be apparent to one skilled in the art.

We claim:

1. A mass spectrometer, comprising:
an ion source,
a vacuum interface including a skimmer unit and an extractor unit,
a Mattauch-Herzog style mass spectrometer, and
a multichannel monolithic semiconductor detector.

2. The mass spectrometer according to claim 1, further comprising an electrostatic sector field pre-filter configured to achieve carrier gas ion/analyte ion separation.

3. The mass spectrometer according to claim 1, wherein the ion source is an inductively coupled plasma (ICP) ion source substantially near ground potential.

4. The mass spectrometer according to claim 1, further comprising two or more pumping ports located symmetrically in a vacuum interface for inductively coupled plasma mass spectrometry (ICP-MS).

5. The mass spectrometer according to claim 1, wherein the skimmer and extractor units are configured to be removed as a single unit, and without disconnecting an electrical connection to an extractor lens unit.

6. The mass spectrometer according to claim 1, wherein the mass spectrometer is configured to use an ion-molecule or -atom chemistry in a collision or reaction cell to achieve carrier gas or interferent ion/analyte ion separation.

7. The mass spectrometer according to claim 1, wherein the Mattauch-Herzog style mass spectrometer is mounted onto an optical bench.

8. The mass spectrometer according to claim 7, wherein the Mattauch-Herzog style mass spectrometer comprises a permanent magnet.

9. The mass spectrometer according to claim 1, wherein the multichannel monolithic semiconductor detector comprises charge collection areas, amplifiers, multiplexers and signal conditioning electronics.

10. The mass spectrometer according to claim 1, wherein the multichannel monolithic semiconductor detector is configured to have two different gains and/or two different sizes of charge collecting areas.

11. The mass spectrometer according to claim 1, wherein the multichannel monolithic semiconductor detector is separated from the magnet by a conductive electrically isolated and electrically floatable mask.

12. The mass spectrometer according to claim 11, wherein the mask is configured to be at a potential of the detector or at a potential of the magnet.

13. The mass spectrometer according to claim 1, further comprising:
floatable read-out electronics; and
a data acquisition system,
wherein the floatable read-out electronics is configured to communicate with the data acquisition system via an optical data link.

14. The mass spectrometer according to claim 1, further comprising one or more thermoelectric detector cooling elements.

15. The mass spectrometer according to claim 13, wherein a galvanic separation of the detector is provided via ceramic of the one or more thermoelectric detector cooling elements.

16. The mass spectrometer according to claim 1, further comprising a contactless temperature sensor arranged to measure the temperature of the multichannel monolithic semiconductor detector.

17. The mass spectrometer according to claim 1, wherein the multichannel monolithic semiconductor detector is removably mounted to an optical bench.

18. The mass spectrometer according to claim 1, wherein the mass spectrometer is configured to be capable of measuring the full inorganic mass range from Li⁶ to U²³⁸ simultaneously in less than four measurements.

19. A method of mass spectrometry, comprising:
using the mass spectrometer according to claim 1 to perform mass spectrometry on a substance; and
outputting results of the mass spectrometry to a data acquisition system.

20. The method of claim 19, further comprising displaying results of the mass spectrometry via a user interface.
